(19) United States
(12) Patent Application Publication
(10) Pub. No.: US 2025/0166346 A1
(43) Pub. Date: May 22, 2025

(54) AUTONOMOUS VISION-BASED GEOREGISTRATION

(71) Applicant: Technology Innovation Institute-Sole Proprietorship LLC, Masdar City (AE)

(72) Inventors: Daniel Tortei, Abu Dhabi (AE); Eloy Roura, Abu Dhabi (AE); Najwa Aaraj, Abu Dhabi (AE)

(73) Assignee: Technology Innovation Institute- Sole Proprietorship LLC., Masdar City (AE)

(21) Appl. No.: 18/766,823

(22) Filed: Jul. 9, 2024

Related U.S. Application Data
(60) Provisional application No. 63/514,026, filed on Jul. 17, 2023.

(51) Int. Cl. G06V 10/74; G06T 7/73; G06V 10/82; G06V 20/13; G06V 20/17

(52) U.S. Cl. CPC G06V 10/74; G06T 7/74; G06V 10/82; G06V 20/13; G06V 20/17; G06T 2207/10032

(57) ABSTRACT

Systems, methods, and computer-readable media for aerial localization in the absence of satellite (e.g., global navigation satellite system (GNSS)) signals while flying over heterogeneous environments. The present embodiments provide a training strategy for robust cross-seasonal image matching in complex, real-world environments. The challenge put forward is to successfully localize a UAV flying over both densely and sparsely populated areas by means of image registration. To this end, the focus of the present embodiments can be on devising loss components to a visual recognition network that adequately embeds the diverse feature types on the ground. A normalized error metric can be provided as well in order to render a conceptually different method comparable to the present approach. The present technical contributions can provide robust visual recognition algorithms in challenging natural environments.

### CROSS-REFERENCE TO RELATED APPLICATION

This application claims priority to U.S. Provisional Application Ser. No. 63/514,026, filed Jul. 17, 2023, which is incorporated by reference in its entirety.

### TECHNICAL FIELD

This disclosure relates to systems, methods, and computer-readable media for aerial localization in the absence of satellite signals while flying over heterogeneous environments.

### BACKGROUND

Aerial navigation can be performed onboard any manned (or unmanned) aerial vehicle. For example, an airplane or an unmanned aerial vehicle (UAV) can be used to perform various tasks, such as to assist in a search-and-rescue task. However, in many instances, the vehicle can enter a region where satellite communication is unreliable or unavailable, which can be referred to as a global navigation satellite system (GNSS)-denied environment.

In such instances, visual geo-registration can be performed to determine a position of (or “re-localize”) the vehicle for timely and efficient reduction of eventual drifts of on-board odometry. This can be performed by matching aerial images (e.g., images from one or more cameras onboard the vehicle) at high altitudes (e.g., above an altitude of 1,000 meters, 10,000 meters, etc.) against orthorectified and georeferenced images from satellites.

Particularly, many solutions for feature representation and aggregation may not be adequate in cases when traveling at higher altitudes and/or when matching against cross-seasonal images (e.g., images depicting the environment in summer or winter), which can be due to flying altitude induced features aliasing bias and domain shift, respectively.

In order to combat these concerns, an effective training process can be implemented towards achieving more robust feature embeddings. Further, an evaluation technique can evaluate various techniques for geolocating aerial images, with results being normalized and able to show improved similarity in terms of Euclidean distance between embeddings, which can be used for increased re-localization accuracy.

### SUMMARY

Systems, methods, and computer-readable media for aerial localization in the absence of satellite (e.g., global navigation satellite system (GNSS)) signals while flying over heterogeneous environments are provided. In some cases, an alternative positioning system can be based on visual information. For instance, using cameras and other sensors, UAVs can collect visual data of their environment and use it to determine their position. Nevertheless, real-time (or near real-time) processing of visual data, sensor fusion, and the development of accurate and efficient computer vision algorithms can be particularly challenging and of significant importance for a complete (or partially) autonomous flight to enable operations such as search and rescue, surveillance, and inspection over GNSS denied environments.

The present embodiments provide a training strategy for robust cross-seasonal image matching in complex, real-world environments. The challenge put forward is to successfully localize a UAV flying over both densely and sparsely populated areas by means of image registration. To this end, the focus of the present embodiments can be on devising loss components to a visual recognition network that adequately embed the diverse feature types on the ground. A normalized error metric can be provided as well in order to render a conceptually different method comparable to the present approach. The present technical contributions can provide robust visual recognition algorithms in challenging natural environments.

In a first example embodiment, a method for training an aerial image matching model and georeferencing image data using a trained aerial image matching model is provided. The method can include obtaining a set of training data that includes at least a set of aerial images and a set of satellite reference images. Each of the set of aerial images and the set of satellite reference images can be georeferenced to uniquely identify position information depicted in each image. Each of the set of satellite reference images can include map-view images forming an aerial map of an area. Each of the set of aerial images can include frames from an imaging device mounted on an aerial vehicle. The set of aerial images can be stitched to obtain the same aerial map formed in the set of satellite reference images.

The method can also include training an aerial image matching model. The training of the aerial image matching model can include sampling one or more triplets. Each triplet can include a set of three image patches of a same dimension. The set of three image patches can be randomly cropped from any of the set of aerial images and the set of satellite images.

The training of the aerial image matching model can also include randomly sampling a center location of each anchor of the triplets. At least a length of a radius distance can be maintained between a pair of anchor patches from different triplets. The training of the aerial image matching model can also include sampling positive patches of each of the one or more triplets by randomly sampling a location within a predefined radius of the center location.

The training of the aerial image matching model can also include sampling negative patches of each of the one or more triplets by sampling a location exceeding the predefined radius of the center location.

The method can also include computing a network loss by generating a soft margin loss as a logarithmic function of an amount of anchor-sample overlap and a difference between a Euclidean distance of embeddings of anchor-positive patches and a Euclidean distance of embeddings of anchor-negative patches within the triplets. The anchor-sample overlap and the difference between the Euclidean distances can be weighted by a convergence factor. Computing the network loss can also include generating a regularization loss as a logarithmic function of a kernel and an embedding. The network loss can be a weighted sum of the soft margin loss and the regularization loss weighted by a weighting factor.

The method can also include training the aerial image matching model using at least the computed network loss. The method can also include identifying, using the trained aerial image matching model, a best match of any of the set of aerial images based on a comparison between any of the set of aerial images and the set of satellite reference images.

In another example embodiment, a system is provided. The system can include an imaging device onboard an aerial vehicle and a computer in electrical communication with the imaging device. The computer can be operative to obtain a set of aerial images from the imaging device.

The computer can also be operative to obtain a set of satellite reference images from a dataset. Each of the set of satellite reference images can be georeferenced to uniquely identify position information depicted in each of the set of satellite reference images. The computer can also be operative to identify, using a trained aerial image matching model, a position of any of the set of aerial images based on a comparison between any of the set of aerial images and the georeferenced set of satellite reference images.

The training of the aerial image matching model can include sampling one or more triplets. Each triplet can include a set of three image patches of a same dimension. The set of three image patches can be randomly cropped from any of the set of aerial images and the set of satellite images.

The training of the aerial image matching model can also include randomly sampling a center location of each anchor of the triplets. At least a length of a radius distance can be maintained between a pair of anchor patches from different triplets. The training of the aerial image matching model can also include sampling positive patches of each of the one or more triplets by randomly sampling a location within a predefined radius of the center location.

The training of the aerial image matching model can also include sampling negative patches of each of the one or more triplets by sampling a location exceeding the predefined radius of the center location.

The computer can also be operative to compute a network loss by generating a soft margin loss as a logarithmic function of an amount of anchor-sample overlap and a difference between a Euclidean distance of embeddings of anchor-positive patches and a Euclidean distance of embeddings of anchor-negative patches within the triplets. The anchor-sample overlap and the difference between the Euclidean distances can be weighted by a convergence factor. Computing the network loss can also include generating a regularization loss as a logarithmic function of a kernel and an embedding. The network loss can be a weighted sum of the soft margin loss and the regularization loss weighted by a weighting factor.

The computer can also be operative to train the aerial image matching model using at least the computed network loss. The computer can also be operative to identify, using the trained aerial image matching model, a best match of any of the set of aerial images based on a comparison between any of the set of aerial images and the set of satellite reference images.

In another example embodiment, a computer-readable storage medium containing program instructions for a method being executed by an application is provided. The application can comprise code for one or more components that are called by the application during runtime. Execution of the program instructions by one or more processors of a computer system can cause the one or more processors to perform steps comprising obtaining a set of training data. The set of training data including at least a set of training images and a set of satellite reference images. Each of the set of satellite reference images can be georeferenced to uniquely identify position information depicted in each of the set of satellite reference images. The set of training images can be part of a dataset that includes multiple terrains and both urban and rural environments with the set of training images captured during multiple seasons.

The execution of program instructions by one or more processors of a computer system can further cause the one or more processors to train an aerial image matching model. The training of the aerial image matching model can include sampling one or more triplets. Each triplet can include a set of three image patches of a same dimension. The set of three image patches can be randomly cropped from any of the set of aerial images and the set of satellite images.

The training of the aerial image matching model can also include randomly sampling a center location of each anchor of the triplets. At least a length of a radius distance can be maintained between a pair of anchor patches from different triplets. The training of the aerial image matching model can also include sampling positive patches of each of the one or more triplets by randomly sampling a location within a predefined radius of the center location.

The training of the aerial image matching model can also include sampling negative patches of each of the one or more triplets by sampling a location exceeding the predefined radius of the center location.

The execution of program instructions by one or more processors of a computer system can furth cause the one or more processors to compute a network loss. Computing the network loss can include generating a soft margin loss as a logarithmic function of an amount of anchor-sample overlap and a difference between a Euclidean distance of embeddings of anchor-positive patches and a Euclidean distance of embeddings of anchor-negative patches within the triplets. The anchor-sample overlap and the difference between the Euclidean distances can be weighted by a convergence factor. Computing the network loss can also include generating a regularization loss as a logarithmic function of a kernel and an embedding. The network loss can be a weighted sum of the soft margin loss and the regularization loss weighted by a weighting factor.

The execution of program instructions by one or more processors of a computer system can further cause the one or more processors to further train the aerial image matching model using at least the computed network loss. The execution of program instructions by one or more processors of a computer system can further cause the one or more processors to identifying, using the trained aerial image matching model, a best match of any of the set of aerial images based on a comparison between any of the set of aerial images and the set of satellite reference images.

In any of the example embodiments, training of the aerial image matching model further comprises augmenting any of the sampled aerial images by performing any of a perspective transform, a pure rotation, a scaling, and/or a blurring process.

In any of the example embodiments, each anchor point specifies a georeferenced position in an environment. Further, a subset of the set of satellite reference images can have georeferenced positions within the radius of each anchor point.

In any of the example embodiments, the aerial image matching model is a convolutional neural network (CNN) model.

In any of the example embodiments, the CNN model includes one or more aggregation layers of a vector of locally aggregated descriptors (netVLAD) with 32 clusters.

In any of the example embodiments, the CNN model includes a fully connected layer with an output embedding dimension which include values of 1024, 2048, or 4096.

In any of the example embodiments, the set of aerial images are obtained from an image device onboard the aerial vehicle, and wherein the set of aerial images are nadir images of an environment from an altitude above a ground level.

In any of the example embodiments, the set of aerial images are part of a dataset that includes multiple terrains and both urban and rural environments.

In any of the example embodiments, the set of satellite reference images are captured during multiple seasons.

In any of the example embodiments, a matched Euclidean error and an upper boundary on a matching error in matching any of the set of aerial images to any of the set of satellite reference images can be determined for the trained aerial image matching model and for at least one other image matching model. Further, a normalized error in matching any of the set of aerial images to any of the set of satellite reference images can be calculated for both of the trained aerial image matching model and the at least one other image matching model based on the matched Euclidean error and the upper boundary of the matching error determined for both of the trained aerial image matching model and the at least one other image matching model. The normalized error can provide an objective comparison of different image matching techniques.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1A illustrates an example set of aerial images and satellite reference images according to an embodiment.

FIG. 1B is an example flow process for training an aerial image matching model and georeferencing image data using a trained aerial image matching model according to an embodiment.

FIG. 2A is a first flow process for identifying a best match for an aerial image using a trained aerial image matching model according to an embodiment.

FIG. 2B is a flow process for training an aerial matching model according to an embodiment.

FIG. 3 illustrates an example system for training an aerial image matching model and determining a best match for an aerial image using the trained aerial image matching model according to an embodiment.

FIG. 4 is an example graphical representation of model accuracy for different model types according to an embodiment.

FIG. 5 is a graphical representation of a model loss for different model types according to an embodiment.

FIG. 6 provides a series of images comparing conceptually different approaches of image matching according to an embodiment.

FIG. 7 illustrates a first set of images illustrating image matching of a first example technique compared to the techniques as described in the present embodiments using another dataset according to an embodiment.

FIG. 8 illustrates a second set of images illustrating image matching of a first example technique compared to the techniques as described in the present embodiments using an urban dataset according to an embodiment.

FIG. 9 illustrates a third set of images illustrating image matching of a first example technique compared to the techniques using the dataset as described in the present embodiments according to an embodiment.

FIG. 10 is a block diagram of a special-purpose computer system according to an embodiment.

### DETAILED DESCRIPTION

Aerial vehicles can travel about an environment to perform various tasks. Particularly, autonomous aerial navigation is a rapidly growing field of research and development, with an unmanned aerial vehicle (UAV) having the potential to change how aircraft operate. With the advent of advances in sensor technologies, artificial intelligence, and machine learning algorithms, autonomous aerial navigation is becoming increasingly sophisticated and capable.

For example, a UAV can be programmed to fly complex tasks, carry out surveillance and search-and-rescue operations, deliver a payload, and perform a range of other tasks with or without human intervention. However, developing reliable and safe autonomous navigation systems for aircraft presents a number of technical and practical challenges. Particularly, one problem can include aerial localization in regions with low or no access to satellite communication systems (e.g., GNSS) while flying over heterogeneous environments.

In many cases, to address such situations, a UAV can use cameras and other sensors to obtain visual data of their environment (e.g., ground-view images) and use such data to determine their position and orientation. Nevertheless, real-time processing of visual data, sensor fusion, and the development of accurate and efficient computer vision algorithms can be particularly challenging and of significant importance for a complete autonomous flight to enable operations such as search and rescue, surveillance, monitoring, and inspection over GNSS denied environments. Localization can include a crucial process for UAV navigation systems, which can be solved in a relative or an absolute manner.

In many cases, this can be addressed with the onboard Inertial Measurement Unit (IMU) systems, where gyroscopes and accelerometer readings are integrated over time and fused with GNSS measurements to compensate for any accumulated drift. In vision-based navigation systems, relative localization can be solved by analyzing the visual changes from one frame to another, such as a process known as Visual Odometry (VO) for example, where the concept can relate to estimating camera displacement by tracking the movement of feature points in the image. Feature points can generally be distinctive and include easily recognizable patterns in the image, such as corners, edges, or texture patterns. Nevertheless, this technique may suffer from the accumulated error over time, rendering it insufficient for long range flights, where accurate absolute localization may become unavoidable and techniques such as loop closure with Simultaneous Localization and Mapping (SLAM) approaches or image geo-localization strategies are used.

Further, there are several factors that can complicate the image matching process due to the nature of visual data. For example, urban scenarios can present very structured data compared to non-populated areas, such as a forest or desert, where unstructured environments can be depicted. In another example, flat lands can have very low-textured information presenting aliasing patterns that create complex variations of natural imagery. Further, cross-seasonal changes can impact the landscape and its vegetation, a fact that makes satellite imagery inconsistent over the year.

Another factor can include the distortion of the image due to the acquisition perspective, where nadir imagery can provide a more consistent view of the Earth's surface (perpendicular to the ground and orthorectified), whereas oblique imagery can be obtained from the UAV with rotational changes during the flight. Further, occlusions (e.g., lighting and shadows) can be included in the image data. Additionally, processing large amounts of image data in real-time can be computationally demanding. Vision based navigation has historically been a very active research topic, where classical approaches have been widely explored such as feature-based methods. Despite its popularity, such a technique can lack discriminating power in low contrast and homogeneous images with limited scale and rotation invariance, and also can be sensitive to noise and occlusions. For this reason, deep features can be a better choice to obtain robust image description. Nevertheless, generalization of such approaches can be rather difficult and large amounts of data are often needed to train these models.

The present embodiments relate to aerial localization in the absence of satellite (e.g., global navigation satellite system (GNSS)) signals while flying over heterogeneous environments. In some cases, an alternative positioning system can be based on visual information. For instance, using cameras and other sensors, UAVs can collect visual data of their environment and use it to determine their position. Nevertheless, real-time (or near real-time) processing of visual data, sensor fusion, and the development of accurate and efficient computer vision algorithms can be particularly challenging and of significant importance for a complete (or partially) autonomous flight to enable operations such as search and rescue, surveillance, and inspection over GNSS denied environments.

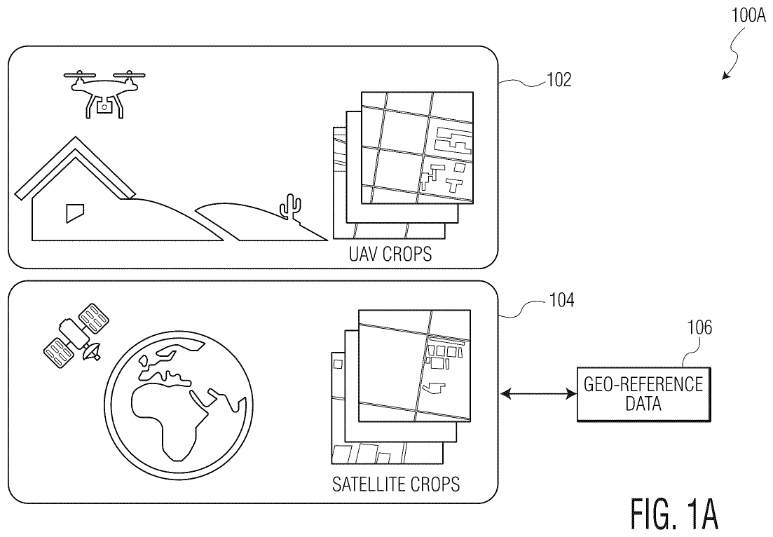

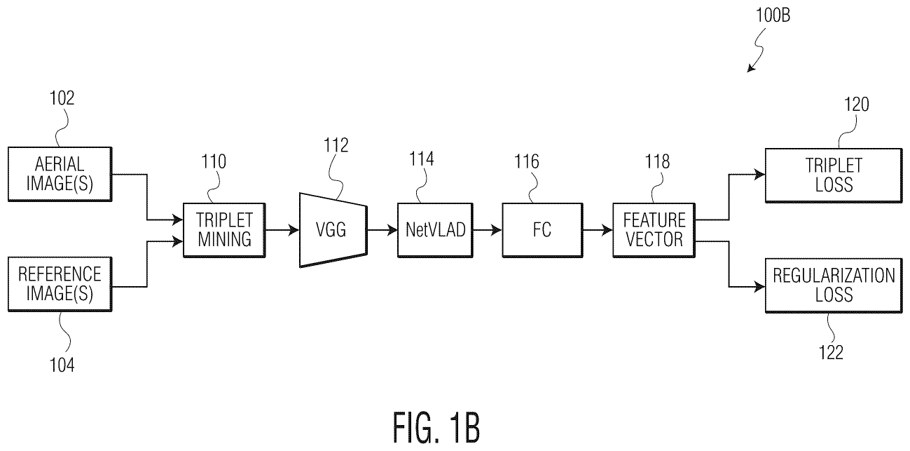

The systems and methods as described herein can obtain both aerial images and satellite reference images to be used to train an aerial image matching model. FIG. 1A is an illustration 100A of an example set of aerial images 102 and satellite reference images 104. As shown in FIG. 1A, aerial images 102 can include a set of images captured from an aerial vehicle (e.g., an unmanned aerial vehicle) that may form an aerial map. The aerial images 102 can be augmented to modify clarity and focus of the images in training of the aerial image matching model. Further, satellite reference images 104 can include a series of images captured by one or more satellite sources. The images 102, 104 can be geo-referenced, with geo-reference data 106 specifying location information of each image.

Localization can include a crucial process for UAV navigation systems, which can be solved in a relative or an absolute manner. A first example technique can include Visual Odometry (VO), which can suffer from the accumulated error over time, rendering it insufficient for long range flights. Other techniques can focus on absolute localization by means of georeferenced image matching techniques.

Further, there can be several factors that can complicate the image matching process due the nature of visual data. In the first place, urban scenarios can present a very structured data compared to non-populated areas, such as forests or desert, where completely unstructured environments can be provided. In this second class of environments, flat lands can have very low-textured information presenting aliasing patterns that create complex variations of natural imagery. Cross-seasonal changes can also affect the landscape and its vegetation, a fact that makes satellite imagery inconsistent over the year.

Another factor can include the distortion of the image due to the acquisition perspective, where nadir imagery can provide a consistent view of the Earth's surface and oblique imagery can be obtained from the UAV with rotational changes during the flight. On top of all the above-mentioned challenges, systems can account for occlusions, lighting, and shadows.

Both classical (e.g., hand-created features) approaches and deep learning (learned features) approaches have generally been widely explored. The first set of approaches can lack discriminating power in low contrast and can be susceptible to scale and rotation of the camera. The latter can compensate for any drawbacks of the first approaches; however the challenge can relate to generalization. Some techniques can compare image retrieval approaches in geo-localization context and exposes, however, despite these efforts, when tested on challenging environments, can perform poorly. A challenge can be how to improve the quality of the embeddings, such as discriminative power, robustness, transferability and computational efficiency.

Further, image geo-registration methods can be divided into key-point and image feature description matching approaches. While both key-point description and image description techniques can involve extracting visual features from an image, these techniques can differ in their scope and purpose. Key-point description can focus on extracting and describing distinctive points in an image, while image description can focus on describing the overall visual content of the image.

Many key-point features description techniques can focus on matching corresponding points between images based on local invariant features. However, big deformations (e.g., scale, rotation, perspective or illumination) can cause image match failures and more sophisticated approaches may be needed.

In registration of remote sensing images, various techniques can include improved versions of classic descriptors by generating more robust and reliable point pairs or by enhancing the base descriptor with different color spaces and noise image reduction strategies. The combination of feature extraction, feature description, and matching techniques can be used to address the image matching problem and its associated issues of robustness and efficiency. One technique can include the development of deep descriptors to learn local features of images. The use of a machine learning model (e.g., a convolutional neural network (CNN) model) can improve precision due to the capacity of extracting low-level features, however it can be resource intensive in terms of data consumption and its applicability may be limited to the related imagery data used during training.

In some instances, deep neural networks can be used that rely on image features to predict a homography matrix that aligns two images. In some cases, the deep neural networks can use latent features to describe the homography between the images which can then be refined with a Lucas-Kanade algorithm. The present embodiment as described herein can provide improved results in terms of accuracy and robustness. In some cases, a limitation can include needing an accurate prior location so that the estimated transformation falls into the range of potential matchings.

Many CNN based approaches can aim to preserve relevant information while mapping high-dimensional data (e.g., UAV image patches) to a lower-dimensional space (embeddings). In many cases, using higher amount of context from the UAV patch can overcome the cross-seasonal perspective matching for satellite images. In many cases, a Euclidean distance between UAV images and map embeddings can be used to solve a cross-domain matching between an urban segmented base map and a satellite view. In other cases, a model can be used to learn a season-invariant similarity measure able to successfully perform cross-seasonal matching between UAV and orthorectified maps based on a CNN. It has been shown that cross-view image matching networks can have the capacity of learning considerate domain shift. In some instances, image retrieval approaches can be used in a geo-localization context. A challenge in such techniques can be how to improve the quality of the embeddings, such as discriminative power, robustness, transferability, computational efficiency. The present embodiments relate to a training methodology for image matching of both urban and complex natural cross-seasonal aerial images. It can be presumed that base maps are sampled at approximately one meter ground sampling distance (GSD) and that UAV query images are their warped cross-seasonal counterparts.

FIG. 1B is an example flow process 100B for training an aerial image matching model and georeferencing image data using a trained aerial image matching model. At 110, aerial images 102 and satellite reference images 104 can be used for triplet mining 110. Triplet mining 110 can include sampling the images 102, 104 to identify a set of three image patches of a same dimension.

The triplets can be fed into a visual geometry group (VGG) model 112. The VGG can include a multi-layer convolutional neural network (CNN) architecture for image processing. The architecture of this model can include multiple layers, such as 16 or 19 layers, for example. The VGG 112 can be used for feature extraction from the images. An output of the VGG can include feature maps fed into the NetVLAD 114.

A NetVLAD 114 is a neural network layer that represents a number (e.g., 32) of clusters, followed by a fully connected layer with the output embedding dimension of 4096. The NetVLAD 114 can obtain the feature maps and cluster the maps to a K-nearest neighbor. Further, the NetVLAD 114 can output a new set of feature maps that include a set of distances of each feature map to the cluster centers. The number of cluster centers (K) can be predetermined, such as a value of 32, for example.

A fully connected (FC) 116 layer can obtain sets of features that describe an image patch. The features can be flattened into a single 1-D array. The FC can output nodes (e.g., with a predetermined size Ndim of the feature vector). Within the FC layer 116, inputs can be mapped to outputs in a fully connected graph, where each connection is a weight learned during training.

The Feature Vector 118 can include an output of the FC layer 116. Each element of the Feature Vector can include an output of a ReLU function, which can include an input of a dot product of weights and flattened input features.

The output of the feature vector 118 can result in triplet loss 120 and regularization loss 122. The triplet loss 120 (or soft margin loss) can include a logarithmic function of an amount of anchor-sample overlap of the one or more anchor points and a distance between the positive patches and the negative patches within the one or more triplets. This loss can be weighted by a convergence factor. A regularization loss 122 can include a logarithmic function of a kernel and an embedding. A network loss is a weighted sum of the soft margin loss and the regularization loss weighted by a weighting factor.

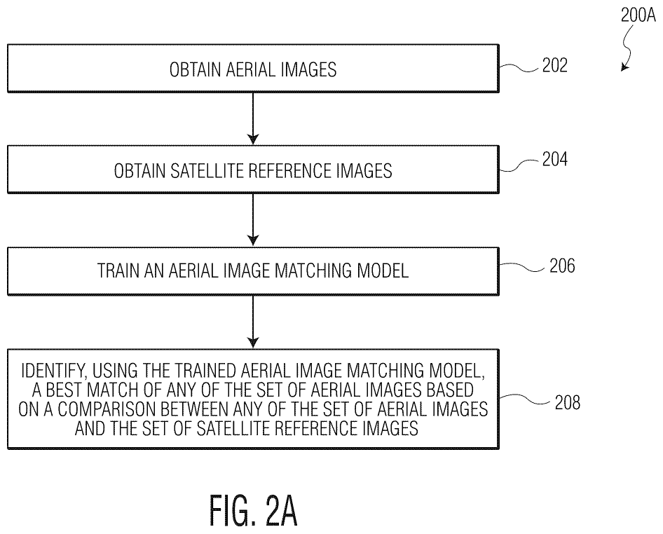

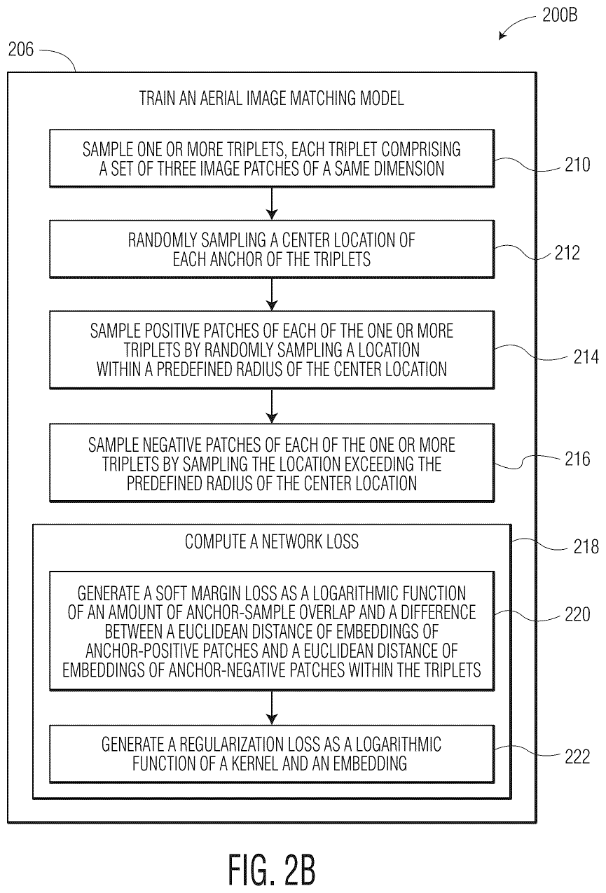

As noted above, the present embodiments can relate to training an aerial image matching model and determining a best match for an aerial image using the trained aerial image matching model. For example, identifying a best match of a set of aerial images can be used to derive a position of the aerial vehicle, as the matched images are georeferenced. FIG. 2A is a first flow process 200A for identifying a best match for an aerial image using a trained aerial image matching model.

At 202, a set of aerial images can be obtained. The set of aerial images can be images captured by an aerial vehicle (e.g., a UAV). The aerial images can be a ground-view image from an elevated altitude as the vehicle is traveling.

At 204, a set of satellite reference images can be obtained. The set of satellite reference images can include images captured from one or more satellite sources. The satellite reference images can include any of a variety of different images from different satellite sources. Further, georeferencing data (e.g., coordinates) can be assigned to each satellite reference image. The satellite reference images (and any aerial images for training) can be used for training the aerial image matching model as described herein.

At 206, the aerial image matching model can be trained. Training the aerial image matching model can include sampling various features from training data (e.g., satellite reference images, aerial images) and computing a network loss as described herein. Training the aerial image matching model is described in greater detail with respect to FIG. 2B.

At 208, a best match of any of the set of aerial images can be identified using the trained aerial image matching model based on a comparison between any of the set of aerial images and the set of satellite reference images. This can include the trained aerial image matching model comparing aerial images with satellite reference images to determine satellite reference images that have a closest match to what is depicted in the aerial image. Responsive to determining the best match, a position of the aerial vehicle can be identified using the geo-reference data associated with the selected satellite reference image.

FIG. 2B is a flow process 200B for training an aerial matching model 206. At 210, training the aerial matching model can include sampling one or more triplets. Each triplet can include a set of three image patches of a same dimension. The set of three image patches can be randomly cropped from any of the set of aerial images and the set of satellite images used as training images.

At 212, training the aerial matching model can include randomly sampling a center location of each anchor of the triplets. At least a length of a radius distance can be maintained between a pair of anchor patches from different triplets.

At 214, training the aerial matching model can include sampling positive patches of each of the one or more triplets. This can be performed by randomly sampling a location within a predefined radius of the center location.

At 216, training the aerial matching model can include sampling negative patches of each of the one or more triplets. This can be performed by sampling a location exceeding the predefined radius of the center location.

Further, at 218, a network loss can be computed. The network loss can be used to further train the aerial image matching model with increased performance.

At 220, computing the network loss can include generating a soft margin loss as a logarithmic function of an amount of anchor-sample overlap and a difference between a Euclidean distance of embeddings of anchor-positive patches and a Euclidean distance of embeddings of anchor-negative patches within the triplets. The anchor-sample overlap and the difference between the Euclidean distances can be weighted by a convergence factor; and

At 222, computing the network loss can include generating a regularization loss as a logarithmic function of a kernel and an embedding. The network loss can be a weighted sum of the soft margin loss and the regularization loss weighted by a weighting factor.

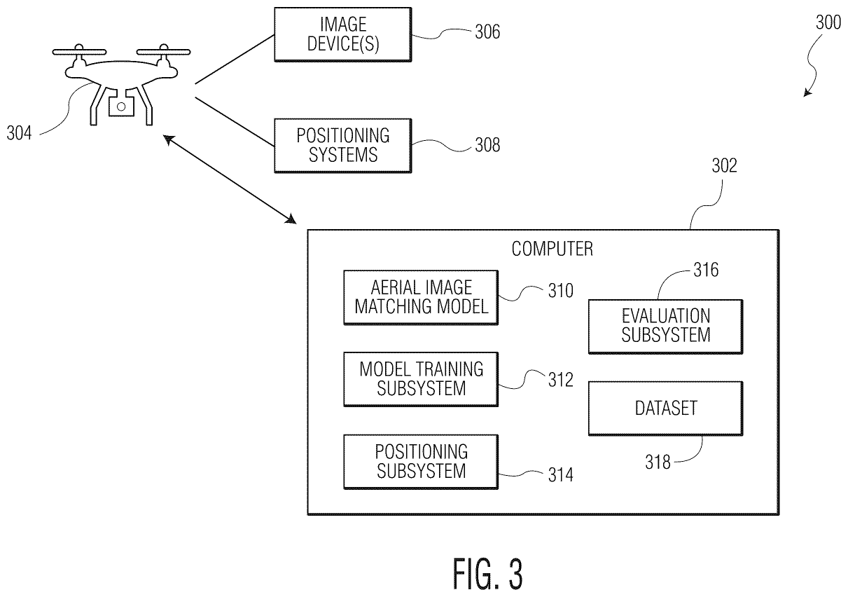

FIG. 3 illustrates an example system 300 for training an aerial image matching model and determining a best match for an aerial image using the trained aerial image matching model. As shown in FIG. 3, the system 300 can include any of a computer 302 (or series of interconnected computing devices) and an aerial vehicle. The aerial vehicle 304 can include a manned or unmanned vehicle, such as a UAV. The computer 302 can be onboard the vehicle 304 or remote from (and in electrical communication with) the vehicle 304. In some instances, computing nodes can be disposed both onboard the UAV 304 and remote from the UAV 304 such that data is transmitted between computing nodes to perform processes as described herein.

The vehicle 304 can include one or more image devices 306 and positioning systems 308. The image devices 306 can include cameras or similar devices capable of capturing images (or video) of the ground below the vehicle 304. Positioning systems 308 can include devices and associated software (e.g., GNSS systems) capable of determining a position of the vehicle 304.

The computer 302 can include any of an aerial image matching model 310, a model training subsystem 312, positioning subsystem 314, evaluation subsystem 316, and a dataset 318. The aerial image matching model 310 can obtain aerial images and determine a best match to satellite reference images as described herein.

The model training subsystem 312 can train the model 310 to increase the performance of the model 310. For instance, the model training subsystem 312 can sample various aspects of training images and compute a network loss as described above.

The positioning subsystem 314 can identify a position of the aerial vehicle based on the geo-reference data associated with the matched satellite reference image(s) identified by the model 310. For example, the positioning subsystem 314 can retrieve geo-reference data (e.g., coordinates) for the matching satellite reference image and determine a position of the aerial vehicle using the coordinates. The positioning subsystem 314 can continually derive a position of the vehicle 304 using newly identified satellite reference images as the vehicle travels 304 without a satellite-based connection.

The evaluation subsystem 316 can retrieve multiple image matching techniques and perform an objective comparison between the techniques as described herein. Further, the dataset 318 can include a plurality of cross-seasonal and multi-terrain images captured for training of the aerial image matching model 310.

A first example technique can rely on image features from a convolutional neural network (CNN) to predict a homography matrix that aligns two cross-seasonal images. The proposed method shows good results in terms of accuracy and robustness. However, the biggest limitation of such an approach can be the need of an accurate prior location so that the estimated transformation falls into the range of potential matchings. In a second example, a Euclidean distance between UAV images and a segmented ground map embeddings is used in image matching. Although this work features a successful cross-domain shift, it may not handle cross-seasonal data. A third example can use a CNN model to learn season-invariant similarity measure between a UAV image and Google Earth satellite image. Such techniques can use a network that is shallow, and the embedding vector can be an order of magnitude smaller than the present network, and the training strategy may not take into consideration the quality of image embeddings.

In some instances, let

$$f ( \cdot ) : {ℝ}^{q \times q} ⟶ {ℝ}^{d} \qquad ( Equation 1 )$$

be an embedding function, I:

$${ℝ}^{n \times n} and Q : {ℝ}^{q \times q} \qquad ( Equation 2 )$$

can be the search area and query areas respectively, with condition that q≤n. The embodiments can find k nearest neighbors of embedding y=f(Q) within a set of embeddings Sₓ=f(I) with the metric being Euclidean distance:

$$‖ y - {x}^{′} ‖ \leq {min}_{{x}^{″} ∈ {S}^{2}} ‖ y - {x}^{″} ‖ , ∀ {x}^{′} ∈ {S}^{1} \qquad ( Equation 3 )$$

where S¹ and S² can be disjoint subsets of Sₓ s.t.|S¹|+|S²|=|Sₓ| (Equation 4). The number of nearest neighbors can be defined as k=|S¹|. The cardinality of Sₓ can be dependent on the number of sliding windows of the query image within the search image. The system can keep track of the center position of each embedding (u, v) and the matched position of the query image within the search area is simply deduced as a k-average:

$${l}_{matched} = \frac{1}{k} {\sum }_{i}^{k} ( {u}_{i} , {υ}_{i} ) \qquad ( Equation 5 )$$

The same embedding function can be used for both y and Sₓ as a large domain-shift inducing variation may not be expected during one matching process.

In this problem setting, the accuracy of the registration can be directly tied to the cardinality of Sₓ: the higher the amount of overlap between two adjacent query images (and thus the higher |Sₓ|), the lower the minimal registration error. Thus, the challenge can be to match embeddings that are contextually close, i.e., that can have high correlation. In contrast to other approaches, the present embodiments may not seek to refine the matching by a particle filter and may not use priors to the matching process, rather, the present embodiments seek to solely rely on quality of embeddings for registration. This can set out a requirement of local sensitivity and global uniqueness of the embeddings in the context of the search area. This can be especially challenging when having aliasing patterns and natural scenery in the search area. A contrasting of the loss function can be leveraged to add a regularization component to it for the sake of adequate feature representation for the application of image matching. The embeddings can project on a unit hypersphere with smooth transitions between the parts, representing feature types such as: dunes, farms, roads, vegetation, buildings etc., without an explicit discretization of these types into classes.

The present embodiments provide both a training and evaluation methodology relating to determining a position of an aerial vehicle. More particularly, the present embodiments can introduce a loss function which can add a weighting factor based on the amount of anchor-sample overlap to soft margin triplet loss and can introduce a regularization loss component. Further, the embodiments can provide an evaluation metric proposition for comparing similarity metric approaches to regression approaches. Additionally, datasets can include different terrains (e.g., urban, desert, forest) with cross-seasonal images from different sources.

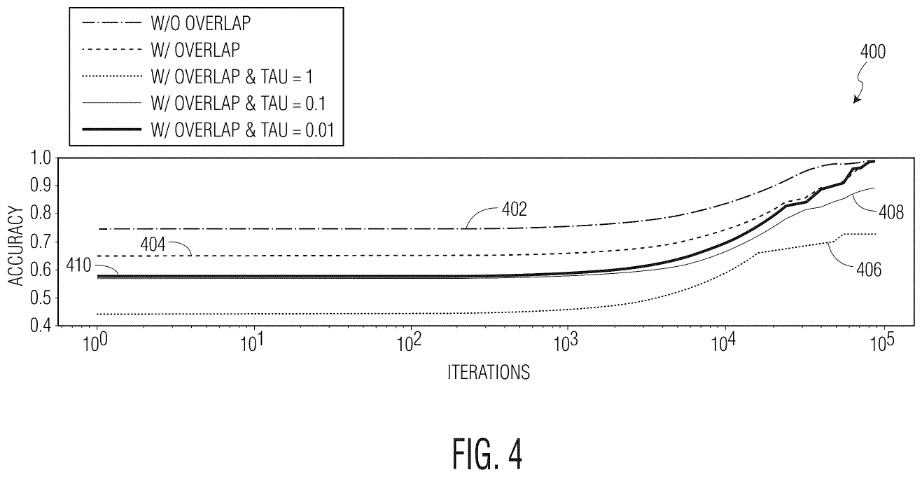

FIG. 4 is an example graphical representation 400 of model accuracy for different model types. For example, as shown in FIG. 4, an accuracy of a model (Y-axis) given a number of iterations (X-axis) can differ based on whether an overlap is not present (e.g., with trendline 402 without overlap), whether an overlap exists (e.g., at 404), whether overlap exists with any of tau=1 (e.g., at 406), 0.1 (e.g., at 408), and 0.01 (e.g., at 410). Further, in FIG. 4, as the number of iterations increases, the accuracy can increase to final accuracy values.

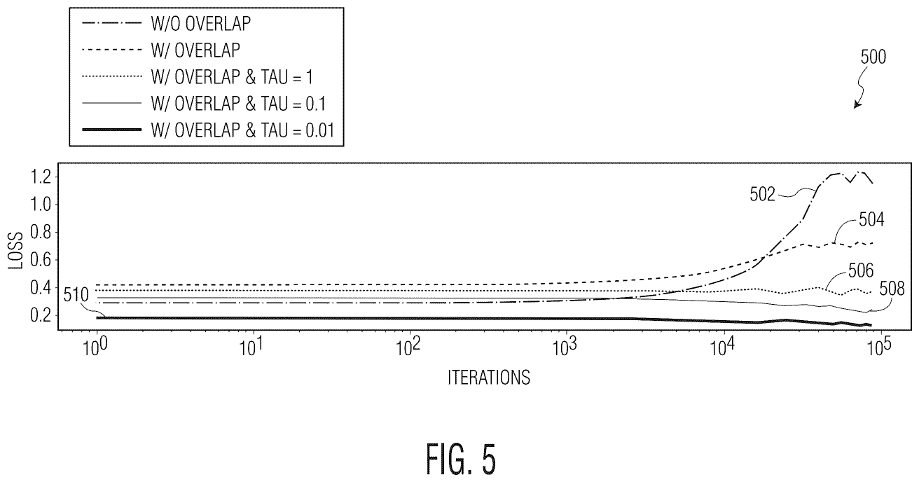

FIG. 5 is a graphical representation 500 of a model loss for different model types. As shown in FIG. 5, as the number of iterations increase, the model loss can change. For instance, a model without overlap (e.g., trendline 502) can have model loss increase substantially. Further, a model with overlap (e.g., 504) and models with overlap and a tau of 1 (e.g., 506), 0.1 (e.g., 508), and 0.01 (e.g., 510) may not have the loss increase as the iterations increase.

The graphs in FIGS. 4-5 can depict learning curves for model accuracy on a validation set (e.g., FIG. 4) and the value of the calculated loss (e.g., FIG. 5). Curves of trainings with different parameters (e.g., #1 through #5) can be compared in order to show impact the present techniques to a loss function (which is training #1: no overlap matrix and no additional regularization loss). In general, the validation accuracy curve shows convergence (albeit slower) when using the anchor-samples overlap matrix (B matrix) and also adding of a regularization loss at the same time.

The training methodology can be used for image matching of both urban and complex natural cross-seasonal aerial images for UAV geo-localization. The present embodiments can match UAV images to satellite basemap images (e.g., obtained from QGIS open-source software). The network used to perform image matching can have aggregation layers pruned to only netVLAD with a lower number of clusters, followed by a fully connected layer with the output embedding dimension of any of 1024, 2048, or 4096. The training as described herein can reduce this vector by using principal component analysis once the training has converged.

In order to compare techniques as described in the present embodiments to other techniques, an evaluation methodology can be introduced. Many evaluation techniques such as regression methods, can differ conceptually to other approaches, and such evaluation methods can make a fair comparison with other techniques. The evaluation methodology can be simply summarized as calculating a normalized error: e*=d/d *. In this case, d* can stand for the upper boundary on the matching error of a given approach (i.e., the maximum possible error) and d can be the matched Euclidean error. This introspective metric can then be used to compare conceptually different approaches of image matching with the application of onboard UAV geo-registration in mind.

Because of domain-shift inducing variation between two distinctive matching processes and local sensitivity of the feature embedding, the present embodiments can learn representations that embed features closely onto unit hypersphere. A goal of such processes can be to train a network capable of inferring embeddings that transition smoothly on the unit hypersphere between different feature types. The present systems and methods can use contrastive soft margin loss:

$$Lmargin = ln ( 1 + e α \cdot B \cdot D ) \qquad ( Equation 6 )$$

$$D = ‖ A - P ‖ - ‖ A - N ‖ \qquad ( Equation 7 )$$

α can include the convergence factor, B can include the amount of anchor-samples overlap in terms of intersection over union (IoU) metric, A, P, and N can include triplet samples and D can include the triplet distance. The purpose of B can be penalizing of hard negatives can be higher than usual IoU with the anchor. In addition, the present systems can make use of regularization loss that aims normalizing the embeddings onto the unit hypersphere, which can be based on a radial basis function (RBF) kernel G(x, y) applied to an embedding.

x:Luniform=logE[G(x,y)] (Equation 8)

This loss component can compute the average L2 regression norm of output network tensors in a minibatch, which can effectively measure deviation from the unit hypersphere of embeddings. The final network loss function can be a weighted sum of two losses with weighting factor (t):

$$L = Lmargin + τ Luniform \qquad ( Equation 9 )$$

As in many dead reckoning and VO-backed applications, the higher the uncertainty of position estimate is, the search area can increase. Nevertheless, in the present embodiments, a ratio can be defined between sizes of the query image and search area by setting an upper boundary on size of the matching zone as N≤3Q. Secondly, a small number & spatial temporal (s.t.) ζ<<Q can be defined.

Further, triplets of size Q×Q pixels (px) can be sampled from an N× N px image patch. For instance, positive samples can be randomly sampled within a radius of ζ px around anchors' centers. Anchors can be sampled spatial temporal (s.t.), where at least Manhattan distance of length ζ can be maintained between each anchor pair. Negative samples of a given triplet can be all positive samples from all other triplets.

It can be shown that the above sampling strategy can produce a densely populated B matrix and that this sampling strategy is the reason weighing is necessary as noted above. Another consequence can be that many anchor-negative pairs have high IoU. The triplets can be augmented by random linear transformations, such as a perspective transform, pure rotation, scale and blurring. The positive and negative samples may, in some instances, never be taken from the same source map.

During training, loss can be computed within the sampled triplet and also by swapping positive samples with anchors. Both measures can be obtained independently as noted above and are averaged together to obtain Lmargin. The reason behind adding a weaker loss (less IoU than the original triplet) by intra-triplet swapping can be to counterweight the effect of B, and to avoid overfitting on hard negatives.

The network as described herein can include aggregation layers that are pruned to only netVLAD with a number (e.g., 32) of clusters, followed by a fully connected layer with the output embedding dimension of 4096. One branch of a Siamese network can have ˜40 million parameters. This can be fed into the network via a single channel 512×512 input.

A dataset including at least desert data can be used for the purpose of training and testing. The reference images in the dataset can be obtained from various satellite sources, such as YANDEX, BING, ESRI and GOOGLE satellite imagery, for example. This dataset can also include seven areas from the Middle East region, covering a total of approx. 930 km² (790 km² is used for training, 100 km² for validation and 40 km² for testing), for example. As each aerial image is taken from a different source and at different times of the year, they can be used one against another as cross-seasonal source maps during training. Spatial resolution of the collected satellite imagery in the dataset can be around 1 m GSD.

The network can be trained on single channel input of size Q=512 px. The batch size can be 24 and within each item there can be an anchor and 8 positive samples. An optimizer can be chosen to be used as solver with default values for betas (0.9 and 0.999, respectively). An initial learning rate can be set at 5^{e-7}, and learning rate decay can be set to 5 epochs. Dropout rate after VGG convolutional layers can be set to 40%. The present embodiments can leverage a practice of multi-stage training of networks with triplet loss: after the loss has converged, a second stage can be run with in-batch hard samples mining. Five representative training runs can be compared: (1) L without B matrix and τ=0, (2) L with B matrix and τ=0, (3) L with B matrix and τ=1, (4) L with B matrix and τ=.1, (5) L with B matrix and τ=.01, with each being run for 13 epochs.

Validation accuracy can be calculated as a percentage of top 1 matches within a minibatch. This can mean whether the best match is found within the minibatch. For instance, if there are 200 samples in a minibatch, a top 1 match for the first samples can mean the system is capable of retrieving a matching pair from a database that is its exact counterpart (e.g., a UAV to satellite patch). A top 5 match can indicate that the matching pair is within the five best retrieved pairs. This validation accuracy can be a metric that is rigorous in terms of retrieval metrics.

Learning curves related to validation accuracy may be seen on FIG. 4 whereas the evolution of uniformity losses are on FIG. 5. As a note, the loss gradients may not be calculated on uniformity loss components in various training runs, and that their reporting on FIG. 5 are for the purpose of evaluation using the techniques described herein. By comparing one technique to others, it can converge the fastest albeit with highest uniformity loss. Another technique can catch up with a first technique in later stages of training, indicating the lagging of the modified Lmargin due to penalizing of hard samples. The uniformity loss can also be considerable. This metric can be much lower in third, fourth, and fifth example training runs as the final loss is also partly minimized from gradients from the uniformity metric there. However, validation accuracy in the third and fourth training runs may not be satisfactory, leaving the fifth training run as the best choice of the last three runs. This indicates that on the data, one can be using t that is two orders of magnitude lower compared to weighing of Lmargin.

Two criteria can be taken into account for best model selection: generalization capacity in context of localization as specified above over an unseen area, and algorithmic (and storage) complexity due to matching of embeddings. When comparing the generalization capacity of various techniques on a desert testing dataset, this dataset can slightly outperform the other two (2-4% increase in localization accuracy). The matching process as described herein can be of various complexities and thus reducing the size of the embeddings can play a crucial role for operations on board UAVs due to limited computing resources. By applying dimensionality reduction on weights of the network's ultimate layer, the size of embeddings can be reduced by a factor of two. As a note, the model trained using the fifth example training run can exhibit the least degradation in generalization capacity (≤3%), compared to 7-13% degradation for models trained by prior training runs.

As described above, various techniques can be used to determine a position of a vehicle in heterogeneous environments. Further, the techniques can be evaluated against one another via various evaluation metrics. For instance, a model can be compared to relevant alternative techniques to determine performance of the model against models employing different techniques.

The choice of approaches to compare against the model can be due to various reasons. For example, models can be compared from a similar environmental setting to a specific application (e.g., aerial, close to nadir imagery from higher altitudes). Models can also be compared based on application (e.g., cross-seasonal matching) or code, model checkpoints, and dataset availability between models.

However, transfer learning may not be able to be applied on training data based on the model checkpoints to various models. This can be due to losses being above a threshold and training not being converged. An assumption for such losses and lack of convergence can be due at least in part due to higher complexity of data and relative shallowness of other models in comparison to the present model.

Other techniques can report poor results in specific environments (e.g., forest areas), while other techniques can also manually select structured samples in their testing set. The models can be compared for their generalization capabilities by inferring each model on all available testing datasets.

When considering external sources, an aim can be to gather aerial imagery at 1 m GSD resolution to provide a comparison between models. For example, an example dataset can be images taken above the landscapes of Finland. This dataset can represent an area of ˜13 km² in Finnish countryside with an even mixture of structured (houses and roads) and unstructured (forest, flat lands) feature types. Further, these features undergo seasonal variations throughout the year.

Another example dataset can be images depicting parts of an urban environment, such as Boston. As the testing dataset may not be at 1 m GSD resolution, the same cross-seasonal imagery can be downloaded from a satellite source at 1 m GSD. In this example, the total area is ˜18 km², with predominant urban structured (buildings, houses, roads) feature types.

A metric used in such datasets can represent a similarity metric, which can be compared with other metrics by setting k=1 in an embeddings matching pipeline and finding a L2 distance to ground truth. Many techniques can regress alignment vertices, which can be conceptually different to metrics in other models. Furthermore, other techniques can use average corner error as an evaluation metric, which may rely on respective ground truth vertices.

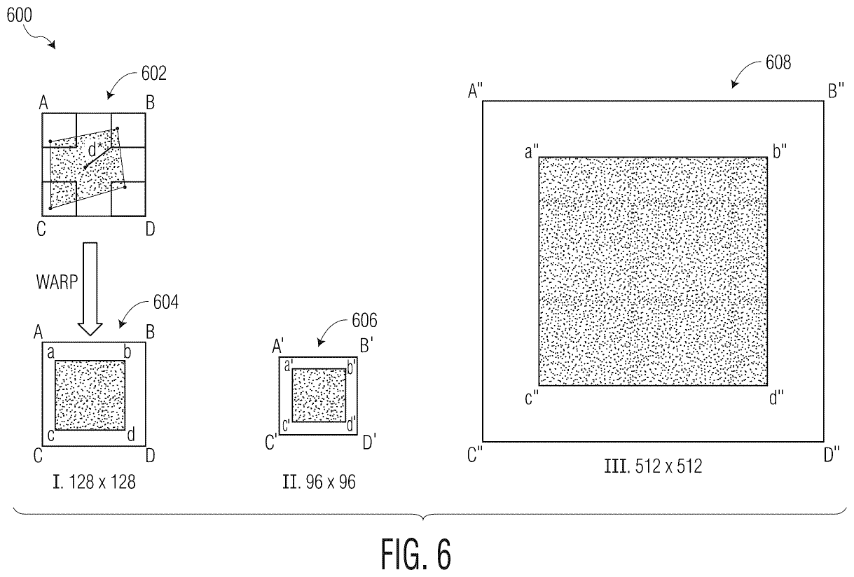

The techniques as described herein can use a more suited metric for handling comparisons, which can be summarized as: e*=d d *. In this example, d * is the upper boundary on the matching error of a given approach and d is the matched L2 error, as explained with respect to FIG. 6.

FIG. 6 provides a series of images 600 comparing conceptually different approaches of image matching. Various approaches can be compared that operate on different input image sizes and predict a regression, a similarity metric and a description vector as outputs, respectively. For example, as shown in FIG. 6, an approach of a first technique can be shown in 602, 604, an approach of a second technique (II) can be shown in 606, and an approach of a third technique (III) can be shown in 608.

Query image extraction can be the same as a first technique, where corners of a polygon (violet) can be randomly sampled in a bounded selection area (i.e., squares next to vertices A, B, C, D) from within a search area. The polygon can afterwards be warped to match the query image dimension. The center ground truth location of the query image can be calculated as the arithmetic mean of the polygon's corners' locations prior to warping.

Search area sampling can include a new search area image being taken from a corresponding map from a different season. The new search area image can remain of same dimension and location as the original search area image. Given that a matching algorithm can ultimately predict a location of the query image within the search image, the largest matching error d * can be defined as the distance from center ground truth location to the location of the edge of the furthest selection area.

As different approaches expect different input sizes for search and query image pairs, and in order to keep the same input perceptive field, these can be resized by downsampling (upscaling in px resolution) and/or by upsampling (downscaling in px resolution). After resizing, the same procedure can be followed to define the largest matching errors. All can then be evaluated as per a more fitting normalized error. As the resizing of inputs puts a first approach into more favorable operational setting in this pipeline, the baseline approach can be shuffled between various approaches as well for the sake of fairness of the evaluation process.

This introspective metric can then be used to compare conceptually different approaches of image matching with the application of onboard UAV georegistration in mind. The example shown in FIG. 6 references warping of a query polygon with an aspect ratio of 1:1.5 with respect to the search area. As a note, in cases of different aspect ratios, corners of the polygon can be sampled from square selection areas that retain same spatial distribution, only the outer boundary of the search area is zoomed out. Finally, evaluation can be applied in the following fashion with respect to query-to-search areas aspect ratio: (i) 1:1.5: vs other techniques vs that in the present embodiments, and (ii) 1:3: in other techniques vs that in the present embodiments as this is the present operational setting.

For sampling of search and query image pairs, data in the dataset can be selected to leverage strategies in each of a variety of approaches. For urban datasets, the search images can be sampled randomly, giving a total of 1200 testing image pairs; and for countryside and desert datasets, search images are sampled by applying a horizontal and vertical stride of 100px in the testing area. Within each search area, query images are sampled by applying a horizontal and vertical stride of 5px. Some techniques can be initialized at the center of the search area and homography estimation is run three times consecutively. Errors can represent mean errors over all image matchings in respective testing areas.

The approach as described herein can outperform other techniques in many or all occasions. On both occasions, the input to the model can be downscaled at least four times, which would mean low flying altitude of the UAV—an operational mode not accounted for in the training pipeline. However, knowing that the network can be close to other techniques in terms of localization errors—can corroborate the robustness of the present approach on both mixed feature type terrains and urban areas that had never been seen before by the model (hence no inductive bias). The present techniques can outperform other approaches by large margin. This indeed can show the need for having a more robust image matching model and an adequate training strategy to cope with challenging environments. Experimenting on the most “Manhattan-alike” testing dataset, the urban dataset, shows that the network also performs well on structured data.

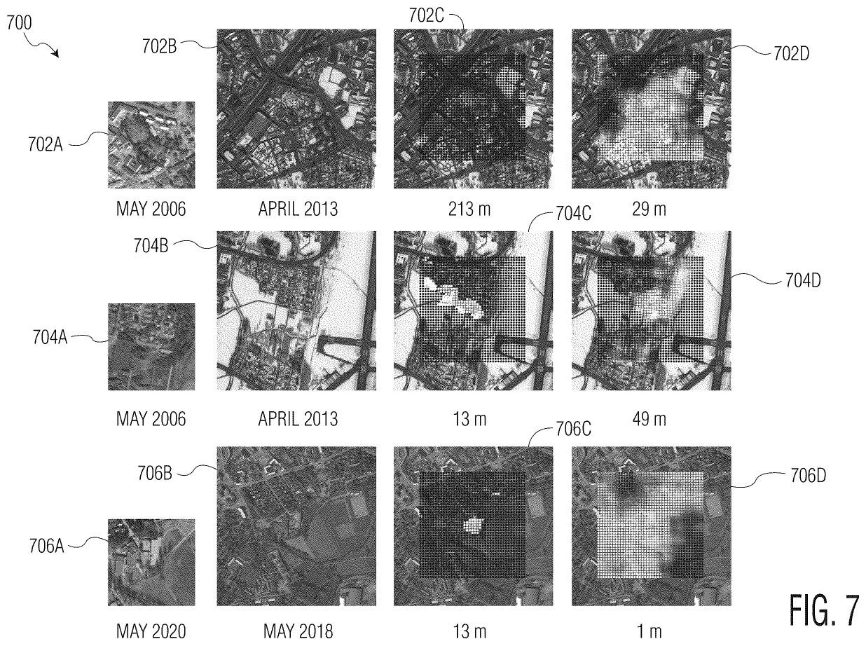

Finally, when comparing matching errors between the two tables, there is a general trend of having a slightly worse performance due to a larger search area over all three compared approaches. In addition to table comparisons, a couple of visualization examples to the localization pipeline can be shown on FIGS. 7-9. On these figures, the present techniques can be compared to other techniques on samples from all three testing datasets in terms of visualizing localization heatmaps. From left to right: a first image can include the query image sampled from the center of search area, a second image can include the search area, a third image can include a localization heatmap based on another technique, and a fourth image can include the localization heatmap based on the present network.

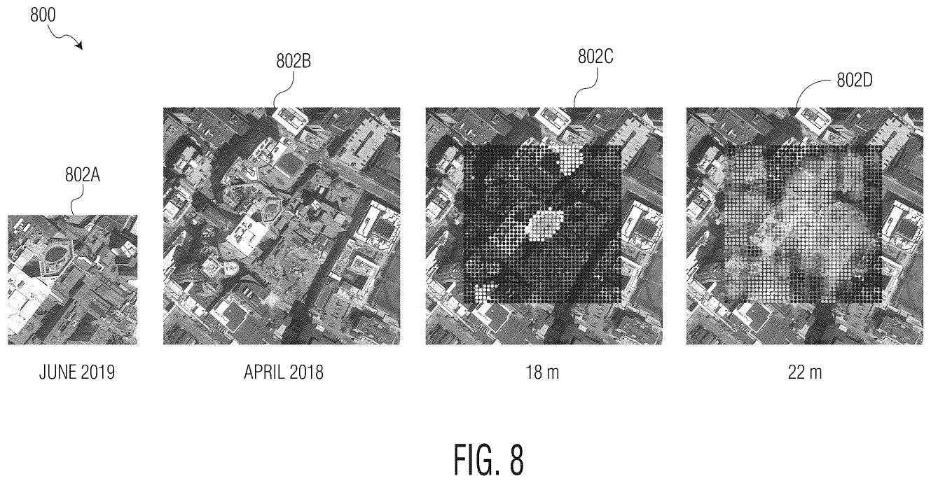

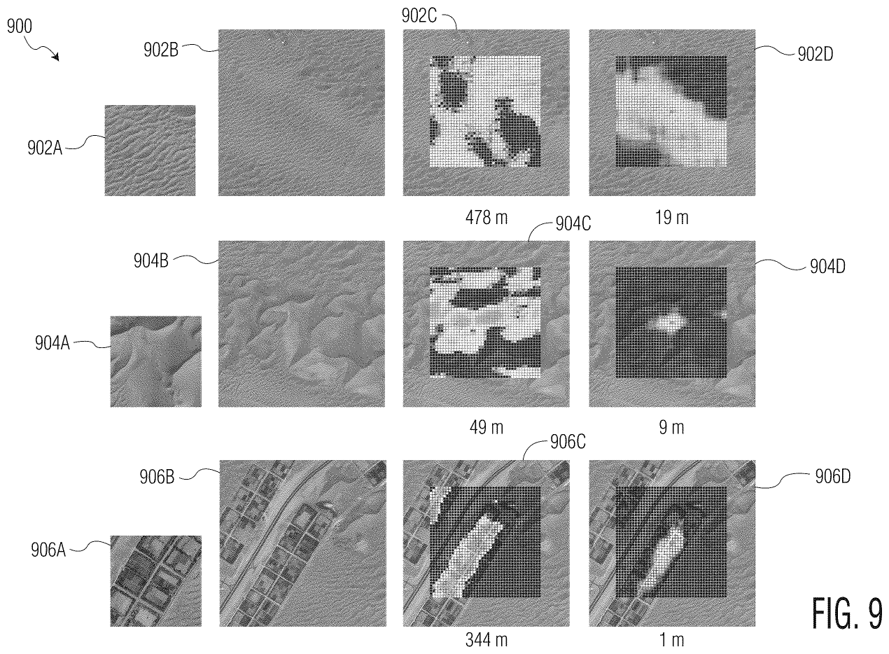

FIG. 7 illustrates a first set of images 700 illustrating image matching of a first example technique compared to the techniques as described in the present embodiments using another dataset. FIG. 8 illustrates a second set of images 800 illustrating image matching of a first example technique compared to the techniques as described in the present embodiments using an urban dataset. FIG. 9 illustrates a third set of images 900 illustrating image matching of a first example technique compared to the techniques using the dataset as described in the present embodiments.

In any of FIGS. 7-9, a first sample of images (e.g., 702A, 704A, 706A in FIG. 7; 802A, 804A, 806A, in FIG. 8; and 902A, 904A, 906A in FIG. 9) can include query images samples from a center of a search area. The second sample of images (e.g., 702B, 704B, 706B in FIG. 7; 802B, 804B, 806B, in FIG. 8; and 902B, 904B, 906B in FIG. 9) can specify the search area from the query image samples. Further, the third sample of images (e.g., 702C, 704C, 706C in FIG. 7; 802C, 804C, 806C, in FIG. 8; and 902C, 904C, 906C in FIG. 9) can specify a localization heatmap for image searching by the first example technique. The fourth sample of images (e.g., 702D, 704D, 706D in FIG. 7; 802D, 804D, 806D, in FIG. 8; and 902D, 904D, 906D in FIG. 9) can include a localization heatmap of the techniques as described herein.

Each point on a heatmap can represent a matching score between the query and the particular crop from search area being matched against the closer the match, the hotter the color. Labels below images three and four represent localization error in meters. An interesting observation is that the spread of false positives (spread of mostly red points) is overall smaller on the present heatmaps, which is due to quality of feature embeddings considering that they are extracted from sample images with significant domain shift.

The present embodiments provide a training strategy for robust cross-seasonal image matching in complex, real-world environments. The challenge put forward is to successfully localize a UAV flying over both densely and sparsely populated areas by means of image registration. To this end, the focus of the present embodiments can be on devising loss components to a visual recognition network that adequately embed the diverse feat types on the ground. A normalized error metric can be provided as well in order to render a conceptually different method comparable to the present approach. The present technical contributions can provide robust visual recognition algorithms in challenging natural environments.

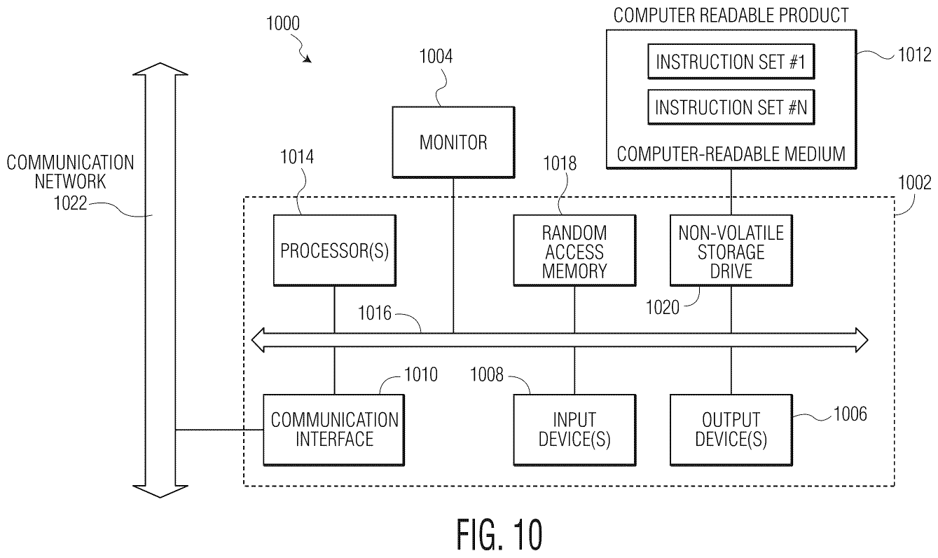

As described above, a computer (e.g., 302 in FIG. 3) can perform image matching to determine a best match to a satellite reference image and determine a position of an aerial vehicle as described herein. FIG. 10 is a block diagram of a special-purpose computer system 1000 according to an embodiment. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 1000 comprises a computer 1002, a monitor 1004 coupled to computer 1002, one or more additional user output devices 1006 (optional) coupled to computer 1002, one or more user input devices 1008 (e.g., keyboard, mouse, track ball, touch screen) coupled to computer 1002, an optional communications interface 1010 coupled to computer 1002, and a computer-program product including a tangible computer-readable storage medium 1012 in or accessible to computer 1002. Instructions stored on computer-readable storage medium 1012 may direct system 1000 to perform the methods and processes described herein. Computer 1002 may include one or more processors 1014 that communicate with a number of peripheral devices via a bus subsystem 1016. These peripheral devices may include user output device(s) 1006, user input device(s) 1008, communications interface 1010, and a storage subsystem, such as random access memory (RAM) 1018 and non-volatile storage drive 1020 (e.g., disk drive, optical drive, solid state drive), which are forms of tangible computer-readable memory.

Computer-readable medium 1012 may be loaded into random access memory 1018, stored in non-volatile storage drive 1020, or otherwise accessible to one or more components of computer 1002. Each processor 1014 may comprise a microprocessor, such as a microprocessor from Intel® or Advanced Micro Devices, Inc.®, or the like. To support computer-readable medium 1012, the computer 1002 runs an operating system that handles the communications between computer-readable medium 1012 and the above-noted components, as well as the communications between the above-noted components in support of the computer-readable medium 1012. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 1008 include all possible types of devices and mechanisms to input information to computer system 1002. These may include a keyboard, a keypad, a mouse, a scanner, a digital drawing pad, a touch screen incorporated into the display, audio input devices such as voice recognition systems, microphones, and other types of input devices. In various embodiments, user input devices 1008 are typically embodied as a computer mouse, a trackball, a track pad, a joystick, wireless remote, a drawing tablet, a voice command system. User input devices 1008 typically allow a user to select objects, icons, text and the like that appear on the monitor 1004 via a command such as a click of a button or the like. User output devices 1006 include all possible types of devices and mechanisms to output information from computer 1002. These may include a display (e.g., monitor 1004), printers, non-visual displays such as audio output devices, etc.

Communications interface 1010 provides an interface to other communication networks and devices and may serve as an interface to receive data from and transmit data to other systems, WANs and/or the Internet, via a wired or wireless communication network 1022. In addition, communications interface 1010 can include an underwater radio for transmitting and receiving data in an underwater network. Embodiments of communications interface 1010 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1010 may be coupled to a computer network, to a FireWire® bus, or the like. In other embodiments, communications interface 1010 may be physically integrated on the motherboard of computer 1002, and/or may be a software program, or the like.

RAM 1018 and non-volatile storage drive 1020 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1018 and non-volatile storage drive 1020 may be configured to store the basic programming and data constructs that provide the functionality of various embodiments of the present invention, as described above.

Software instruction sets that provide the functionality of the present invention may be stored in computer-readable medium 1012, RAM 1018, and/or non-volatile storage drive 1020. These instruction sets or code may be executed by the processor(s) 1014. Computer-readable medium 1012, RAM 1018, and/or non-volatile storage drive 1020 may also provide a repository to store data and data structures used in accordance with the present invention. RAM 1018 and non-volatile storage drive 1020 may include a number of memories including a main random access memory (RAM) to store instructions and data during program execution and a read-only memory (ROM) in which fixed instructions are stored. RAM 1018 and non-volatile storage drive 1020 may include a file storage subsystem providing persistent (non-volatile) storage of program and/or data files. RAM 1018 and non-volatile storage drive 1020 may also include removable storage systems, such as removable flash memory.

Bus subsystem 1016 provides a mechanism to allow the various components and subsystems of computer 1002 communicate with each other as intended. Although bus subsystem 1016 is shown schematically as a single bus, alternative embodiments of the bus subsystem may utilize multiple busses or communication paths within the computer 1002.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for training an aerial image matching model and georeferencing image data using a trained aerial image matching model, the method comprising:
obtaining a set of training data that includes at least a set of aerial images and a set of satellite reference images, wherein each of the set of aerial images and the set of satellite reference images are georeferenced to uniquely identify position information depicted in each image, wherein each of the set of satellite reference images comprise map-view images forming an aerial map of an area, and wherein each of the set of aerial images comprise frames from an imaging device mounted on an aerial vehicle, and wherein the set of aerial images are stitched to obtain a same aerial map formed in the set of satellite reference images;
training an aerial image matching model by:
sampling one or more triplets, each triplet comprising a set of three image patches of a same dimension, wherein the set of three image patches are randomly cropped from any of the set of aerial images and the set of satellite images;
randomly sampling a center location of each anchor of the triplets, wherein at least a length of a radius distance is maintained between a pair of anchor patches from different triplets;
sampling positive patches of each of the one or more triplets by randomly sampling a location within a predefined radius of the center location;
sampling negative patches of each of the one or more triplets by sampling a location exceeding the predefined radius of the center location; and
computing a network loss by:
generating a soft margin loss as a logarithmic function of an amount of anchor-sample overlap and a difference between a Euclidean distance of embeddings of anchor-positive patches and a Euclidean distance of embeddings of anchor-negative patches within the triplets, wherein the anchor-sample overlap and the difference between the Euclidean distances are weighted by a convergence factor; and
generating a regularization loss as a logarithmic function of a kernel and an embedding, wherein the network loss is a weighted sum of the soft margin loss and the regularization loss weighted by a weighting factor;
further training the aerial image matching model using at least the computed network loss; and
identifying, using the trained aerial image matching model, a best match of any of the set of aerial images based on a comparison between any of the set of aerial images and the set of satellite reference images.

2. The method of claim 1, wherein the training of the aerial image matching model further comprises:
augmenting any of the sampled triplets by performing any of: a perspective transform, a pure rotation, a scaling, and/or a blurring process.

3. The method of claim 1, wherein each anchor point specifies a georeferenced position in an environment, and wherein a subset of the set of satellite reference images have georeferenced positions within the radius of each anchor point.

4. The method of claim 1, wherein the aerial image matching model is a convolutional neural network (CNN) model.

5. The method of claim 4, wherein the CNN model includes one aggregation layer of a vector of locally aggregated descriptors (netVLAD) with at least 32 clusters.

6. The method of claim 4, wherein the CNN model includes a fully connected layer with an output embedding dimension which include values of 1024, 2048, or 4096.

7. The method of claim 1, wherein the set of aerial images are obtained from an image device onboard the aerial vehicle, and wherein the set of aerial images are nadir images of an environment from an altitude above a ground level.

8. The method of claim 1, wherein the set of aerial images are part of a dataset that includes multiple terrains and both urban and rural environments.

9. The method of claim 1, wherein the set of satellite reference images are captured during multiple seasons.

10. The method of claim 1, further comprising:
determining, for the trained aerial image matching model and for at least one other image matching model, a matched Euclidean error and an upper boundary on a matching error in matching any of the set of aerial images to any of the set of satellite reference images; and
calculating a normalized error in matching any of the set of aerial images to any of the set of satellite reference images for both of the trained aerial image matching model and the at least one other image matching model based on the matched Euclidean error and the upper boundary of the matching error determined for both of the trained aerial image matching model and the at least one other image matching model wherein the normalized error provides an objective comparison of different image matching techniques.

11. A system comprising:
an imaging device onboard an aerial vehicle;
a computer in electrical communication with the imaging device, where the computer is operative to:
obtain a set of aerial images from the imaging device;
obtain a set of satellite reference images from a dataset, wherein each of the set of satellite reference images are georeferenced to uniquely identify position information depicted in each of the set of satellite reference images; and
identify, using a trained aerial image matching model, a position of any of the set of aerial images based on a comparison between any of the set of aerial images and the georeferenced set of satellite reference images, wherein training the aerial image matching model comprises:
sampling one or more triplets, each triplet comprising a set of three image patches of a same dimension, wherein the set of three image patches are randomly cropped from any of the set of aerial images and the set of satellite images;
randomly sampling a center location of each anchor of the triplets, wherein at least a length of a radius distance is maintained between a pair of anchor patches from different triplets;
sampling positive patches of each of the one or more triplets by randomly sampling a location within a predefined radius of the center location;
sampling negative patches of each of the one or more triplets by sampling a location exceeding the predefined radius of the center location; and
compute a network loss by:
generating a soft margin loss as a logarithmic function of an amount of anchor-sample overlap and a difference between a Euclidean distance of embeddings of anchor-positive patches and a Euclidean distance of embeddings of anchor-negative patches within the triplets, wherein the anchor-sample overlap and the difference between the Euclidean distances are weighted by a convergence factor; and
generating a regularization loss as a logarithmic function of a kernel and an embedding, wherein the network loss is a weighted sum of the soft margin loss and the regularization loss weighted by a weighting factor;
further train the aerial image matching model using at least the computed network loss; and
identify, using the trained aerial image matching model, a best match of any of the set of aerial images based on a comparison between any of the set of aerial images and the set of satellite reference images.

12. The system of claim 11, wherein the aerial image matching model is a convolutional neural network (CNN) model, wherein the CNN model includes one aggregation layer including a vector of locally aggregated descriptors (netVLAD) with at least 32 clusters, and wherein the CNN model includes a fully connected layer with an output embedding dimension of 1024, 2048 or 4096.

13. The system of claim 11, wherein the set of aerial images are nadir images of an environment from an altitude above a ground level.

14. The system of claim 11, wherein the set of training images are part of a dataset that includes multiple terrains and both urban and rural environments, and wherein the set of satellite reference images are obtained from any of a plurality of satellite image sources, and wherein the set of training images captured during multiple seasons.

15. The system of claim 11, wherein the computer is further operative to:
determine, for the trained aerial image matching model and for at least one other image matching model, a matched Euclidean error and an upper boundary on a matching error in matching any of the set of aerial images to any of the set of satellite reference images; and
calculate a normalized error in matching any of the set of aerial images to any of the set of satellite reference images for both of the trained aerial image matching model and the at least one other image matching model based on the matched Euclidean error and the upper boundary of the matching error determined for both of the trained aerial image matching model and the at least one other image matching model, wherein the normalized error provides an objective comparison of different image matching techniques.

16. A computer-readable storage medium containing program instructions for a method being executed by an application, the application comprising code for one or more components that are called by the application during runtime, wherein execution of the program instructions by one or more processors of a computer system causes the one or more processors to perform steps comprising:
obtaining a set of training data, the set of training data including at least a set of training images and a set of satellite reference images, wherein each of the set of satellite reference images are georeferenced to uniquely identify position information depicted in each of the set of satellite reference images, and wherein set of training images are part of a dataset that includes multiple terrains and both urban and rural environments with the set of training images captured during multiple seasons;
training an aerial image matching model by:
sampling one or more triplets, each triplet comprising a set of three image patches of a same dimension, wherein the set of three image patches are randomly cropped from any of the set of aerial images and the set of satellite images;
randomly sampling a center location of each anchor of the triplets, wherein at least a length of a radius distance is maintained between a pair of anchor patches from different triplets;
sampling positive patches of each of the one or more triplets by randomly sampling a location within a predefined radius of the center location;
sampling negative patches of each of the one or more triplets by sampling a location exceeding the predefined radius of the center location; and
computing a network loss by:
generating a soft margin loss as a logarithmic function of an amount of anchor-sample overlap and a difference between a Euclidean distance of embeddings of anchor-positive patches and a Euclidean distance of embeddings of anchor-negative patches within the triplets, wherein the anchor-sample overlap and the difference between the Euclidean distances are weighted by a convergence factor; and
generating a regularization loss as a logarithmic function of a kernel and an embedding, wherein the network loss is a weighted sum of the soft margin loss and the regularization loss weighted by a weighting factor;
further training the aerial image matching model using at least the computed network loss; and
identifying, using the trained aerial image matching model, a best match of any of the set of aerial images based on a comparison between any of the set of aerial images and the set of satellite reference images.

17. The computer-readable storage medium of claim 16, wherein the training of the aerial image matching model further comprises:
augmenting any of the sampled triplets by performing any of: a perspective transform, a pure rotation, a scaling, and/or a blurring process.

18. The computer-readable storage medium of claim 16, wherein the aerial image matching model is a convolutional neural network (CNN) model, wherein the CNN model includes one aggregation layer include a vector of locally aggregated descriptors (netVLAD) with at least 32 clusters, and wherein the CNN model includes a fully connected layer with an output embedding dimension of either 1024, 2048 or 4096.

19. The computer-readable storage medium of claim 16, wherein the set of aerial images are obtained from an image device onboard an unmanned aerial vehicle, and wherein the set of aerial images are ground-view images of an environment from an altitude above a ground level.

20. The computer-readable storage medium of claim 16, wherein the computer is further operative to:
determine, for the trained aerial image matching model and for at least one other image matching model, a matched Euclidean error and an upper boundary on a matching error in matching any of the set of aerial images to any of the set of satellite reference images; and
calculate a normalized error in matching any of the set of aerial images to any of the set of satellite reference images for both of the trained aerial image matching model and the at least one other image matching model based on the matched Euclidean error and the upper boundary of the matching error determined for both of the trained aerial image matching model and the at least one other image matching model.
